(19) United States
(12) Patent Application Publication
(10) Pub. No.: US 2008/0222408 A1
(43) Pub. Date: Sep. 11, 2008

(54) CIRCUIT FOR PROTECTING MOTHERBOARD

(75) Inventor: KUN-PENG LI, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/695,066

(22) Filed: Apr. 2, 2007

(30) Foreign Application Priority Data
Mar. 6, 2007 (CN) 200720200123.5

(51) Int. Cl. G06F 9/00

(52) U.S. Cl. 713/2

(57) ABSTRACT

A circuit for protecting a motherboard includes a power button (30), a first heat-generating component (10) of the motherboard with a first output terminal, a second heat-generating component (40) of the motherboard with a second output terminal, a first switch circuit (20) connected between the first heat-generating component and the power button; and a second switch circuit (50) connected between the second heat-generating component and the power button. Wherein when the first heat-generating component reaches its maximum safe operating temperature, the first output terminal is at low level, the first switch circuit connects the power button to ground to power down the computer and protect the motherboard from overheating; when the second heat-generating component reaches its maximum safe operating temperature, the second output terminal is at high level to turn on the second switch circuit which results in the power button connecting to ground to power down the computer and protect the motherboard from overheating.

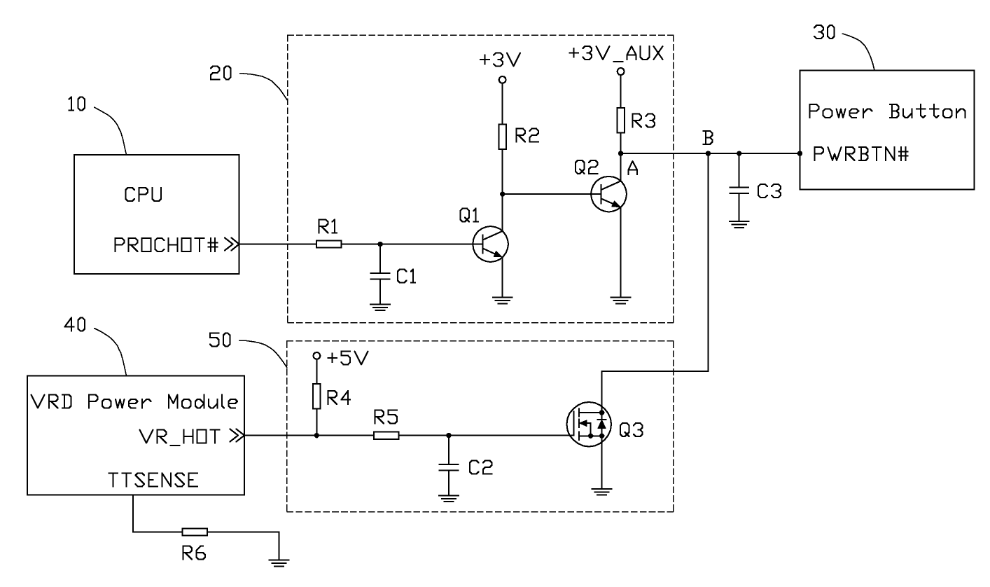

### BACKGROUND OF THE INVENTION

1. Field of the Invention

The present invention relates to circuits for protecting motherboards, and more particularly to a circuit for protecting a motherboard from damage as a result of overheating.

2. Description of Related Art

Motherboards produce a lot of heat after a long working time. If the heat is not dissipated fast enough, components on the motherboards, especially CPUs and VRD (Voltage Regulation Down) modules may burn out and even damage nearby circuits or chips of the motherboards.

To prevent damage to the CPU from overheating, there is a thermal monitor integrated into the processor silicon of the CPU. The thermal monitor includes a highly accurate on-die temperature sensing circuit; a signal (PROCHOT#) that indicates the processor has reached its maximum operating temperature, and registers to determine status as well as a thermal control circuit that can reduce processor temperature by controlling the duty cycle of the processor clocks to maintain a safe operating temperature. When the thermal control circuit has been enabled, processor power consumption will be reduced within a few hundred clock cycles after the thermal sensor detects a high temperature. The thermal control circuit goes inactive once the temperature has been brought back down below the thermal trip point. External hardware can monitor PROCHOT# and generate an interrupt whenever there is a transition from active-to-inactive or inactive-to-active.

However, the above described method may not always work to prevent the VRD power module from overheating, thus the motherboard thereof maybe damaged as a result.

What is needed, therefore, is a circuit for reliably protecting a motherboard from damage due to overheating.

### SUMMARY OF THE INVENTION

A circuit for protecting a motherboard includes a power button, a first heat-generating component of the motherboard with a first output terminal, a second heat-generating component of the motherboard with a second output terminal, a first switch circuit connected between the first heat-generating component and the power button, and a second switch circuit connected between the second heat-generating component and the power button. Wherein when the first heat-generating component reaches its maximum safe operating temperature, the first output terminal is at low level, the first switch circuit connects the power button to ground to power down the computer and protect the motherboard; when the second heat-generating component reaches its maximum safe operating temperature, the second output terminal is at high level to turn on the second switch circuit which connects the power button to ground to power down the computer and protect the motherboard.

Other advantages and novel features will be drawn from the following detailed description of preferred embodiments with attached drawings, in which:

### BRIEF DESCRIPTION OF THE DRAWING

The drawing is a circuit diagram in accordance with a preferred embodiment of the present invention.

### DETAILED DESCRIPTION OF PREFERRED EMBODIMENTS

Referring to the drawing, a circuit for protecting a motherboard in accordance with a preferred embodiment of the present invention includes a first heat-generating component, a power button 30 attached on a front panel of a computer, a first switch circuit 20 connected between the power button 30 and the first heat-generating component, a second heat-generating circuit, and a second switch circuit 50 connected between the power button 30 and the second heat-generating component.

In a preferred embodiment, the first heat-generating component may be a CPU 10 with a PROCHOT# pin being at low level when the CPU reaches its maximum safe operating temperature and at high level when the CPU is operating below the maximum safe operating temperature.

The first switch circuit 20 includes a first transistor Q1 and a second transistor Q2 both of which are bipolar NPN transistors. A base terminal of the first transistor Q1 connects to the PROCHOT# pin of the CPU 10 through a resistor R1 and to ground through a capacitor C1, a collector terminal of the first transistor Q1 connects with a base terminal of the second transistor Q2 and to a +3V voltage source through a second resistor R2, a collector terminal of the second transistor Q2 connects with a common point A connecting to a +3V_AUX standby voltage source through a third resistor R3 and the power button 30, emitter terminals of the first and second transistors connect to ground.

The power button 30 is attached on a front panel of a computer for turning on or off a power supply thereof. The power button 30 has a PWRBTN# pin which is set from high to low for turning on or off the power supply. The PWRBTN# pin connects to ground through a third capacitor C3.

In a preferred embodiment, the second heat-generating component 40 may be a VRD power module mounted on the motherboard which has a VR_HOT pin and a TTSENSE pin. The VR_HOT pin is at high level when the VRD power module 40 reaches its maximum safe operating temperature and at low level when the VRD power module 40 is operating below its maximum safe operating temperature. The TTSENSE pin connects to ground through a thermal sensor R6 for sensing temperature of the VRD power module 40.

The second switch circuit 50 includes a third transistor Q3 which is a N-channel-enhancement MOSFET. A gate of the third transistor Q3 connects to the VR_HOT pin of the VRD power module 40 through a fifth resistor R5 and to ground through a second capacitor C2, a drain of the third transistor Q3 connects with a common point B connecting with the PWRBTN# pin of the power button 30, a source of the third transistor Q3 connects to ground. The VR_HOT pin of the VRD power module 40 further connects to a +5V voltage source through a fourth resistor R4.

Wherein when the CPU 10 reaches its maximum safe operating temperature while the computer is working, the PROCHOT# pin is set from high to low level, the first transistor Q1 is turned off, the second transistor Q2 is turned on, the common point A connects to ground through the conductive second transistor Q2 thus the power supply is turned off for preventing the CPU 10 from overheating; when the VRD power module 40 reaches its maximum endurance temperature, the VR_HOT pin of the VRD power module 40 is set from low to high level to turn on the third transistor Q3 which connects the PWRBTN# pin of the power button 30 to ground to power down the computer and protect the VRD power module 40.

When the CPU 10 and the VRD power module 40 operate below their maximum safe operating temperatures, the second transistor Q2 and the third transistor Q3 are turned off, the PWRBTN# pin connects to ground through the non-conductive transistors and maintain high level, the first and second switch circuits are inactive, and the computer is working normally.

It is to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the invention to the full extent indicated by the broad general meaning of the terms in which the appended claims are expressed.

1. A circuit for protecting a motherboard of a computer comprising:
a power button connecting with a standby voltage source of the computer for powering on or off the computer;
a central processing unit (CPU) mounted on the motherboard with a first output terminal, a thermal monitor being integrated in the CPU to sense the temperature of the CPU;
a voltage regulation down module mounted on the motherboard with a second output terminal, the voltage regulation down module having a TTSENSE pin, a thermally sensitive resistor connecting between the TTSENSE pin and ground to sense the temperature of the voltage regulation down module;
a first switch circuit connected between the first output terminal of the CPU and the power button; and
a second switch circuit connected between the second output terminal of the voltage regulation down module and the power button;
wherein when the CPU reaches its maximum safe operating temperature, the first switch circuit connects the power button to ground to power off the computer for protecting the motherboard from overheating; when the voltage regulation down module reaches its maximum safe operating temperature, the second switch circuit is turned on and connects the power button to ground to power off the computer for protecting the motherboard from overheating;
wherein the first switch circuit comprises a first transistor and a second transistor, a base terminal of the first transistor connects to the first output terminal of the CPU, a collector terminal of the first transistor connects to a voltage source, a base terminal of the second transistor connects with the collector terminal of the first transistor, a collector terminal of the second transistor connects with the power button, emitter terminals of the first and second transistors connect to round; and
wherein the second switch circuit comprises a third transistor, a gate of the third transistor connects to the second output terminal of the voltage regulation down module, a drain of the third transistor connects to the power button, a source of the third transistor connects to ground.

2. (canceled)

3. The circuit as described in claim 1, wherein the first and second transistors are both bipolar NPN transistors.

4. The circuit as described in claim 3, wherein the base terminal of the first transistor connects to the first output terminal through a first resistor, the collector terminal of the first transistor connects to the voltage source through a second resistor, the collector terminal of the second transistor connects to the standby voltage source through a third resistor.

5. (canceled)

6. The circuit as described in claim 1, wherein the third transistor is an N-channel-enhancement MOSFET.

7. (canceled)

8. The circuit as described in claim 1, wherein the first output terminal of the CPU is set from high to low level when the CPU reaches its maximum safe operating temperature, the second output terminal of the voltage regulation down module is set from low to high level when the voltage regulation down module reaches its maximum safe operating temperature.

9-15. (canceled)

16. The circuit as described in claim 1, further comprising a capacitor connecting between the power button and ground.

17. A circuit for protecting a motherboard comprising:
a power button connecting to a standby voltage source via a resistor for powering on or off the computer;
a voltage regulation dawn module mounted on the motherboard having an output terminal and a TTSENSE pin;
a thermally sensitive resistor connecting between the TTSENSE pin and ground to send temperature signals to the voltage regulation down module;
a transistor, a gate of the transistor connecting to the output terminal of the voltage regulation down module, a drain of the transistor connecting to the standby voltage via the resistor, and a source of the transistor connecting to ground;
a central processing unit (CPU) mounted on the motherboard having another output terminal; and
a grounding switch circuit connecting between said another output terminal of the CPU and the power button;
wherein when either the voltage regulation down module or the Cpu reaches its maximum safe temperature, the power button is connected to ground to power off the motherboard for providing heat protection to the voltage regulation down module and the CPU;
wherein the switch circuit connected with the CPU and the power button comprises at least another transistor connecting between the CPU and the power button to power off the motherboard when the CPU reaches its maximum temperature.

18. (canceled)

19. The circuit as described in claim 17, further comprising a capacitor connecting between the gate of the transistor and ground.

20. The circuit as described in claim 17, wherein the voltage regulation down module transforms a temperature signal sent by the thermally sensitive resistor to a high level output signal to turn on the transistor and connects the power button to ground to power off the motherboard when the voltage regulation down module reaches its maximum safe temperature.
